(19) United States
(12) Patent Application Publication
(10) Pub. No.: US 2007/0210737 A1
(43) Pub. Date: Sep. 13, 2007

(54) Window convenience and security system

(76) Inventor: David Brander, Brooklyn, NY (US)

Correspondence Address: Peter J. Phillips;Cooper & Dunham LLP, 1185 Avenue of the Americas, New York, NY, 10036, US

(21) Appl. No.: 11/362,367

(22) Filed: Feb. 24, 2006

(51) Int. Cl. H02P 1/04

(52) U.S. Cl. 318/483

(57) ABSTRACT

A window convenience and security system operates to change the position of a window or door in a structure in response to control information such as detected weather conditions, detected hazardous airborne particles, presence of people, stored time schedules, signals transmitted over a cellular network or voice using voice recognition circuitry.

### BACKGROUND OF THE INVENTION

The present invention relates to a closure control system for controlling the position of closures (e.g., windows and doors) in a building structure in response to various conditions and other parameters.

In residential and commercial buildings, windows provide a number of functions. In cold weather they keep the heat in, and in hot weather they keep the heat and humidity out (for those structures with air conditioning systems). They also provide a view to the outside environment and let in natural full-spectrum light, which is an advantage over limited spectrum artificial light. Windows also provide these features while protecting the interior environs (e.g., window treatments, trim, floors, floor coverings) from precipitation (e.g., snow, rain, sleet, ice and hail), wind, dust, pollen and other particulates, and insect, pest and rodent entry. Windows also keep intruders out and keep residents in, particularly children and pets.

There are times when the occupant of a windowed structure prefers that windows be closed, and there are times when the occupant prefers that the windows be partially or entirely open. For example, when the outside temperature is mild and is acceptable to the occupants, and there is no precipitation or other reasons to keep a window closed, it is generally desirable to open a window partially or entirely to facilitate air circulation for ventilation purposes. However, weather and other conditions may change quickly resulting in a need or desire to close, open or change a window position quickly.

Moving a window between open and closed positions, or to or from intermediate positions, is typically done manually by a person. However, there are situations where the occupant, even if in the windowed room, or close by, does not wish to manually move the window to the desired position. This may be more so the case when a plurality of windows in the structure needs to be changed to a different position. Further, in situations where the occupant is not close by or on the premises and a window position change is needed or desired, the occupant is unable to make the manual change. Examples of such conditions are exterior weather conditions, an intruder near the window or a hazardous air condition inside or out, such as carbon monoxide, gas or smoke, or pollen, weed or dust.

Window control systems have been proposed. U.S. Pat. No. 5,226,256 to Fries relates to a window system having a remote control and sensors. U.S. Pat. No. 5,782,036 to Bertieri et al. relates to a window control system having a remote control. The disclosures of these patents are incorporated by reference herein. Window control systems have also been proposed to change the position of a skylight window upon detection of rain. However, such systems have been limited in features and flexibility.

### SUMMARY OF THE INVENTION

The present invention provides a window convenience and security system which detects various conditions and controls the window position depending on the status of various detected conditions, to provide convenience and security to the occupant of the structure having one or more windows.

The system has the capability to being programmed to open and/or close windows, or to move windows to certain intermediate positions at certain times of the day and may be equipped with detection and alarm system to provide added security for a home.

The system could detect exterior weather conditions such as precipitation, wind, humidity and/or barometric pressure, including changes in these parameters, and change the window position based on these conditions.

The system may also detect the presence of nearby intruders or undesirable animals, and change the window position. The system may also detect the presence of small children, elderly people or pets and change the window position. The system may also detect the time of day and the presence or absence of natural light and change the window position. The system may also detect the presence of smoke and change the window position. The system may also detect the presence of carbon monoxide, natural gas or other gaseous materials which are hazardous to breathe and change the window position.

In addition to, or in lieu of changing window position, the system can institute a communication with medical, fire, police, security or other personnel to take responsive action based on the detected condition.

The system may provide individual detection of conditions at each window, a group of windows (e.g., in a room, floor or group of rooms or floors), or all or substantially all of the windows in a structure or particular oriented wall (e.g., north, south, east or west) of a structure and provide window position adjustment of a single window, a group of windows or all or substantially all of the windows in a structure or particularly oriented wall. For example, if a window has an associated smoke and/or carbon monoxide detector which detects the presence of smoke and/or carbon monoxide at that window, the system may open only that window or a group of windows nearby. If the system is connected to a central smoke and/or carbon monoxide detector in a structure and the detector detects smoke and/or carbon monoxide, a group or all (or substantially all) of the windows can be opened. The same can be implemented in response to other detectable conditions such as natural gas, propane or other conditions mentioned above. In addition to or in lieu of changing a window position, the system can engage a security mode to the structure upon detection of one or more various conditions. The system may also be provided with a sensor which detects whether a person or other object or thing is in the way of the window and inhibits window movement partially or entirely based on the detection, so as to protect the person or thing from being injured or damaged by the window.

The system may be implemented with an electrical/electronic system that would be used in conjunction with windows to provide a number of conveniences and added security. The system may make use of wireless transmission such as short radio, wireless intranet or Bluetooth, and a minimal amount of wiring would be required. The basic system could be comprised of a main control panel, a remote control unit, a drive motor, a motion detector, an alarm unit, and a moisture sensor. The main control panel could be a microprocessor based control unit which would be mounted on a wall at a location selected by the user. The control panel could have a number of pushbutton switches that would be used to open or close window(s), to program specific times for window(s) to be closed, and to initialize the alarm unit that is part of the system. The remote control unit that accompanies the unit could be used to open or close a selected window. The motion sensor and drive motor could be mounted on or adjacent to a window. The motion detector sensor could be comprised of an infrared transmitter that would be mounted on the window sill and a photo sensor that would be mounted on the window frame, above the infrared transmitter. Any movement of the window, when it was closed, or anyone entering through the window when the window was open, would be detected by the motion sensor and the alarm unit would be activated, emitting an audible alarm. The alarm unit could be mounted near the window at another location selected by the user. The drive motor could be positioned adjacent to the window and the drive shaft could be mechanically linked to the window frame. The drive motor could respond to signals generated by the main control panel or the remote control unit to open or close a window. In addition to these capabilities, the system may also include a moisture sensor which would be positioned outside a residence. Whenever rain begins to fall, the moisture would be detected and the sensor would generate a signal which would activate the drive motor which would then close the window(s). The system could be beneficially used by most, if not all, households and the market arena for such a system could be exceptionally large and viable.

The present invention provides a closure control system for use in a building structure, comprising a detector located in the vicinity of a closure for detecting an exterior weather condition in the form of at least one of humidity, air flow speed or barometric pressure change, and for producing a control signal operative to change the position of the closure in response to the detection of the weather condition.

The invention provides a closure control system for use in a building structure, comprising a detector located in the vicinity of a closure for detecting a hazardous air condition, and for producing a control signal operative to change the position of the closure in response to the detection of the condition.

The invention provides a ventilation control system for use in a building structure, comprising a detector for detecting the presence of a hazardous air condition in the structure, and for producing a control signal operative to change the ventilation system in response to the detection of the hazardous air condition.

The invention provides a closure control system for use in a building structure, comprising a detector for detecting the presence of a mammal in the vicinity of a closure, and for producing a control signal operative to change the position of the closure in response to the detection of the mammal.

The invention provides a ventilation control system for use in a building structure, comprising a detector for detecting the presence of a ventilation condition in the structure, and for producing a control signal operative to change the ventilation system in response to the detection of the ventilation condition.

The invention provides a control system for use in a building structure, comprising a detector for detecting the presence of an unrecognized object exterior to the structure, and for producing a control signal operative to change the position of a closure in the structure in response to the detection of said object.

The invention provides a control system for use in a building structure, comprising a detector for detecting the presence of an unrecognized object exterior to the structure, and for producing a communication signal to notify the condition to a remote location.

The invention provides a closure control system for use in a building structure, comprising a controller for storing information regarding the position of a closure based on a time schedule, and for producing a control signal operative to change the position of the closure in response to the time schedule information.

The invention provides a closure control system for use in a building structure, comprising a remote, off-premises controller for producing a control signal indicating the desired position of a closure in a structure, which control signal is communicated from the remote, off-premises controller over a cellular telephone network; and an on-premises controller, for receiving the control signal from the remote, off-premises controller over the cellular telephone network, and for producing a closure position control signal operative to change the position of the closure.

The invention provides a closure control system for use in a building structure, comprising an on-premises detector and controller for detecting the status of and controlling the closure position of a closure on the premises of a building structure; and a remote, off-premises controller for communicating with an on-premises detector and controller over a cellular telephone network, and for determining the status of the closure position from the remote location.

The invention provides a closure control system for use in a building structure, comprising a voice recognition circuit for recognizing a voice command, and a controller for producing a central signal operative to change the position of a closure in response to the voice command.

### BRIEF DESCRIPTION OF THE DRAWINGS

FIG. 1 shows a block diagram of a system according to the invention.

### DESCRIPTION OF A PREFERRED EMBODIMENT

The present invention provides a closure control system for use in a building structure, comprising a detector located in the vicinity of a closure for detecting an exterior weather condition in the form of at least one of humidity, air flow speed or barometric pressure change, and for producing a control signal operative to change the position of the closure in response to the detection of the weather condition.

The weather condition may be humidity, barometric pressure change or air flow speed. The system may further include a precipitation detector for detecting precipitation. The system may include a plurality of closures, and wherein the control signal is operative to change the position of the plurality of closures in response to the detection of the condition. The system may include a manual input control for generating the control signal, to thereby effect change of the position of the closure independent of the detected condition. The system may include a central control unit for generating a control signal operative to change the position of a plurality of closures. The manual input control may be connected to at least one of a main control panel in the structure, a remote control unit, a wired computer, a wireless computer, a telephone circuit or a Palm device. The system may include a communication connection for generating and transmitting a status signal representing the condition to a remote communication reporting location.

The invention provides a closure control system for use in a building structure, comprising a detector located in the vicinity of a closure for detecting a hazardous air condition, and for producing a control signal operative to change the position of the closure in response to the detection of the condition.

The hazardous air condition may be selected from the group consisting of carbon monoxide, smoke, natural gas and propane. The hazardous air condition may be selected from the group consisting of pollen, weed, mold and spores. The detector may detect a hazardous air condition in the exterior of the structure, and wherein the control signal is operative to change the position of the closure toward a closed position in response to the detection of the condition. The detector may detect a hazardous air particle condition in the interior of the structure, and wherein the control system is operative to change the position of the closure toward an open position in response to the detection of the condition. The system may include a plurality of closures, and wherein the control signal is operative to change the position of the plurality of closures in response to the detection of the condition. The system may include a manual input control for generating the control signal, to thereby effect change of the position of the closure independently of the detected condition. The system may include a central control unit for generating a control signal operative to change the position of a plurality of closures. The manual input control may be connected to at least one of a main control panel in the structure, a remote control unit, a wired computer, a wireless computer, a telephone circuit or a Palm device. The system may include a communication connection for generating and transmitting a status signal representing the condition to a remote communication reporting location. The remote communication reporting location may be one of a security company, police, fire, ambulance, and public utility company. The detector may detect a hazardous air condition and provide a control signal for adjusting a ventilation system in the structure.

The invention provides a ventilation control system for use in a building structure, comprising a detector for detecting the presence of a hazardous air condition in the structure, and for producing a control signal operative to change the ventilation system in response to the detection of the hazardous air condition.

The invention provides a closure control system for use in a building structure, comprising a detector for detecting the presence of a mammal in the vicinity of a closure, and for producing a control signal operative to change the position of the closure in response to the detection of the mammal.

The detector may detect the presence of a mammal in the exterior of the structure, and wherein the control signal is operative to change the position of the closure toward a closed position in response to the detection of the mammal's presence. The system may further include a closure path detector to detect the presence of a person or object in the path of the closure, and for inhibiting movement of the closure to a completely closed position in response to detection of the person or object.

The invention provides a ventilation control system for use in a building structure, comprising a detector for detecting the presence of a ventilation condition in the structure, and for producing a control signal operative to change the ventilation system in response to the detection of the ventilation condition.

The ventilation condition may be air flow.

The invention provides a control system for use in a building structure, comprising a detector for detecting the presence of an unrecognized object exterior to the structure, and for producing a control signal operative to change the position of a closure in the structure in response to the detection of said object.

The unrecognized object may be a person or a vehicle.

The invention provides a control system for use in a building structure, comprising a detector for detecting the presence of an unrecognized object exterior to the structure, and for producing a communication signal to notify the condition to a remote location.

The unrecognized object may be a person or a vehicle.

The invention provides a closure control system for use in a building structure, comprising a controller for storing information regarding the position of a closure based on a time schedule, and for producing a control signal operative to change the position of the closure in response to the time schedule information.

The invention provides a closure control system for use in a building structure, comprising a remote, off-premises controller for producing a control signal indicating the desired position of a closure in a structure, which control signal is communicated from the remote, off-premises controller over a cellular telephone network; and an on-premises controller, for receiving the control signal from the remote, off-premises controller over the cellular telephone network, and for producing a closure position control signal operative to change the position of the closure.

The invention provides a closure control system for use in a building structure, comprising an on-premises detector and controller for detecting the status of and controlling the closure position of a closure on the premises of a building structure; and a remote, off-premises controller for communicating with an on-premises detector and controller over a cellular telephone network, and for determining the status of the closure position from the remote location.

The remote off-premise controller may generate a control signal operative to change the closure position from a remote location over the cellular telephone network.

The invention provides a closure control system for use in a building structure, comprising a voice recognition circuit for recognizing a voice command, and a controller for producing a central signal operative to change the position of a closure in response to the voice command.

The voice recognition circuit may be located in a vicinity of the closure or may be located in the remote, off-premises device.

A preferred embodiment of a window convenience and security system will be described to provide one way of making and using the invention. However, the invention is not limited to the embodiment described. The system may also apply to doors as well as windows. As used herein, the term “closure” means a window or door of a structure. The invention will be described with reference to one or more windows, with the understanding that doors may be controlled and used in the same manner.

The window system will be described in connection with a window 1-1 in an exterior wall of a building structure. Window 1-2 represents another window, which could be on the same floor. Windows 2-1 and 2-2 represent other windows which could be on a different floor. The windows may be double hung windows, or other type such as casement. A system will be described in connection with one window 1-1, with the understanding that all of the other windows may be provided with the same associated components and connections.

### Description of a Preferred Embodiment

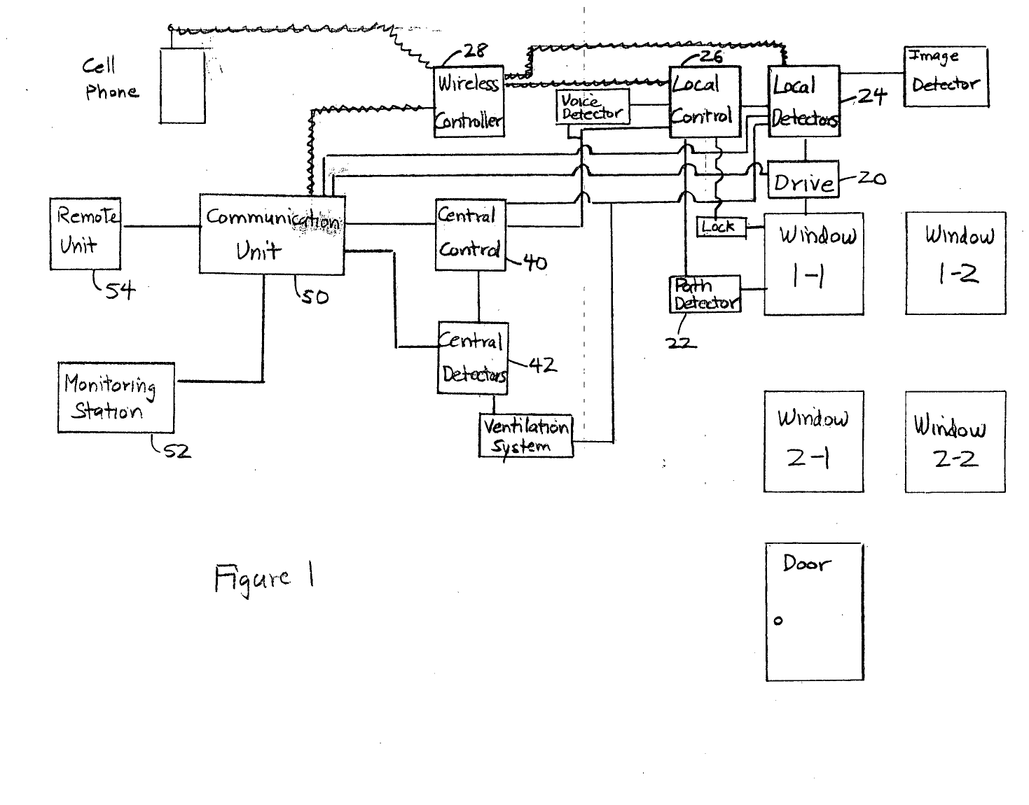

FIG. 1 is a schematic block diagram of a window convenience and security system according to the invention.

The window 1-1 has a drive 20 which enables the window to be moved automatically between open and closed positions, or positions in between. Such drive 20 could be a motor with warm gear in the casement pocket of the window. The window also has a path detector 22 which detects when a person or object is in the path of the window, as a safety precaution so that the window will not close on a person or other living thing. If such is detected, the window may be controlled to stop at a predetermined partially closed position sufficient to preclude entry by intruders, but providing enough opening to not injure, at least seriously, a person or living thing. It is desirable that the window drive have a release mechanism, operable from inside the structure, to disconnect the drive so that the window can be moved manually freely in the conventional manner, for use in emergency evacuation or other situations. The drive mechanism can be arranged so that it can be overridden by manual operation.

In addition to moving a window to a different position, the system can lock the window at that position, either at the fully closed position or any other desired position. A window lock can be any known lock, which can operate using a magnetic operator, electric solenoid or other known means.

The window drive is connected to a local detector 24, which may comprise one or more detectors for detecting conditions inside and/or outside the structure in the vicinity of the window. Such exterior local detectors may include detectors for moisture, precipitation, wind, humidity barometric pressure, ambient light, intrusion (such as infrared or motion), animals, vibration/noise, or other conditions. Interior local detectors may include detectors for smoke, carbon monoxide, natural gas, propane, people, pets, temperature, humidity and intrusion (e.g., unauthorized presence of persons).

The local detectors 24 are connected to a local control unit 26 which receives information from the detectors and makes decisions based on its programming. The local control unit 26 may comprise one or more logic circuits, or a microprocessor. The local control unit may have a key pad for inputting desired control information, security codes, and an override code. The local control unit may have a display which displays status indicators in text form, and/or in colored lights such as LEDs. The local control unit may also have an audible alarm. The local control unit may have a receiver for wirelessly receiving control information from a wireless remote controller 28 used by a person to change the window position independently of the detected conditions, or to change any of the settings in the local control unit, (or central control unit identified below. The local control unit may also include a input transducer such as a microphone to receive voice commands from a user, whereby the local control unit recognizes and process the voice commands to change the window position, or change any of the settings in the local control unit (or central control unit identified below). The local control unit may have an output transducer to output synthesized or recorded voice or other audible signals to and communicate with a user, to acknowledge commands, state status, or announce detected conditions.

The local control 26 is connected to the local detector 24, the drive 20 and to the path detector 22. These connections can be wired or wireless, including Bluetooth, infrared, short radio link or other type. The wireless controller 28 may communicate with one or more of local detectors 24 (to receive status information) for one or more windows. The wireless controller 28 may communicate with one or more local control units 26 for one or more windows to receive status information, to transmit commands, or for other communication as described herein.

The wireless controller 28 may communicate with a central control unit 40 for the entire structure. The central control unit 40 would have all of the control functions of the local control units, and preferably serve as a master control unit to enable changing or control of all or a selected number of the local control units simultaneously, serially or other way.

The system may also have a central detector 42 which may detect interior and/or exterior conditions independently of the local detectors, and others conditions in addition. Such detectors may detect smoke, carbon monoxide, natural gas, propane, temperature, humidity, intrusion and precipitation. The central detector 42 is connected to the central control unit 40 and the local control units 26.

For example, the central detector may detect the presence of smoke, carbon monoxide, gas or propane, and in response issue a control signal to some or all of the local control units 26 to move the windows toward an open position to provide ventilation for the structure.

The central detector may also detect precipitation and issue a control signal to some or all of the local control units 26 to move the windows toward a closed position. The windows so commanded may be all of the windows, or a selected number or group of windows, for example those windows that are downwind of the precipitation, or windows having valuable window treatments or floors, or windows without awnings or below protective roofs.

The central control 40 and central detector 42 may control windows individually, or by groups by wall facing (east, south, west and north), by room, by floor, or other subset, or all of the windows. The central control may control certain groups of windows at different times of the day. For example, the system can change the position of east facing windows in the morning and west facing windows in the afternoon, based on a time schedule or ambient light detection. The windows can be programmed based on time of day, day of the week, and time of the year, having different programs for different time periods.

The local detectors 24, central control unit 40, and central detector 42 are connected to a communication unit 50 in a wired or wireless manner. The communication unit is further connected in a wired or wireless manner to a remote off-premises monitoring station 52 such as a security company, or to a remote off-premises unit 54. The connections between the various units may be done in a wired or wireless manner, such as using short-range radio link, landline or cellular telephone, infrared, Bluetooth or other known communication means.

The monitoring station can monitor the detected conditions, such as smoke, natural gas, carbon monoxide propane and intrusion, and take additional action such as dispatching emergency personnel, and/or communicating further with the resident, wherever they may be, to report the condition and monitoring status.

The detectors according to the invention may comprise cameras or other imaging devices which collect images of objects outside a structure and change window position upon detection of an abnormal or not previously recognized condition, such as an unrecognized person assumed to be an intruder, an unrecognized vehicle, or the like. Other means of recognizing people or objects may be employed such as biometric techniques, infrared sensing, retina scans, or the like. Upon detection of an unrecognized object, the system may communicate with a control station such as a security company, police station or towing company, to report the condition and possibly tow the car if the object is a vehicle.

The system according to the invention may also provide for remote control, by wired or wireless connection to the premises, such as by short-range radio link, landline or cellular telephone, infrared, Bluetooth or other means. A person can contact the central control unit 40 or the local control units 26 and obtain status information about the detected conditions, window positions and control settings. The person can change the settings or effect control of window position or other premises conditions using the telephone, for example. Using a phone, a person can walk or be prompted through a series of menus and effect control using voice commands or touch tone signals on the phone.

The system can be arranged to detect one or more of air circulation, air temperature or humidity inside or outside the premises, and change window position and/or adjust a ventilation system. The system can be used to control the ventilation or the circulation of air, by detecting natural air circulation and/or circulation from a central air or ventilation system, and make appropriate adjustments to the window(s), circulation or ventilation system as desired. For example, the system can be arranged to turn off the ventilation system upon the detection of gas, or the system can be arranged to ventilate upon detection of carbon monoxide.

While one embodiment has been described, numerous variations and modifications will occur to those skilled in the art. The invention is not limited to the embodiment disclosed, and its scope is defined by way of the following claims.

1. A closure control system for use in a building structure, comprising:
a detector located in the vicinity of a closure for detecting an exterior weather condition in the form of at least barometric pressure change over time, and for producing a control signal operative to change the position of the closure in response to the detection of the weather condition.

2. The system of claim 1, wherein the weather condition includes humidity.

3. (canceled)

4. The system of claim 1, wherein the weather condition includes air flow speed.

5. The system of claim 1, further including a precipitation detector for detecting precipitation.

6. The system of claim 1, wherein the system includes a plurality of closures, and wherein the control signal is operative to change the position of the plurality of closures in response to the detection of the condition.

7. The system of claim 1, wherein the system includes a manual input control for generating the control signal, to thereby effect change of the position of the closure independent of the detected condition.

8. The system of claim 1, wherein the system includes a central control unit for generating a control signal operative to change the position of a plurality of closures.

9. The system of claim 7, wherein the manual input control is connected to at least one of a main control panel in the structure, a remote control unit, a wired computer, a wireless computer, a telephone circuit or a Palm device.

10. The system of claim 1, wherein the system includes a communication connection for generating and transmitting a status signal representing the condition to a remote communication reporting location.

11. A closure control system for use in a building structure, comprising:
a detector located in the vicinity of a closure for detecting a hazardous air condition exterior to the structure, and for producing a control signal operative to change the position of the closure in response to the detection of the condition.

12. The system of claim 11, wherein the hazardous air condition is selected from the group consisting of carbon monoxide, smoke, natural gas and propane.

13. The system of claim 11, wherein the hazardous, air condition is selected from the group consisting of pollen, weed, mold and spores.

14. (canceled)

15. (canceled)

16. The system of claim 11, wherein the system includes a plurality of closures, and wherein the control signal is operative to change the position of the plurality of closures in response to the detection of the condition.

17. The system of claim 11, wherein the system includes a manual input control for generating the control signal, to thereby effect change of the position of the closure independently of the detected condition.

18. The system of claim 11, wherein the system includes a central control unit for generating a control signal operative to change the position of a plurality of closures.

19. The system of claim 11, wherein the manual input control is connected to at least one of a main control panel in the structure, a remote control unit, a wired computer, a wireless computer, a telephone circuit or a Palm device.

20. The system of claim 11, wherein the system includes a communication connection for generating and transmitting a status signal representing the condition to a remote communication reporting location.

21. The system of claim 11, wherein the remote communication reporting location is at least one of a security company, police, fire, ambulance, and public utility company.

22. The system of claim 11, wherein the detector detects a hazardous air condition and provides a control signal for adjusting a ventilation system in the structure.

23. A ventilation control system for use in a building structure, comprising:
a detector for detecting the presence of a hazardous air condition in the structure in the form of at least one of pollen, weed, mold and spores, and for producing a control signal operative to change the ventilation system in response to the detection of the hazardous air condition.

24. A closure control system for use in a building structure, comprising:
a detector for detecting the presence and identity of a mammal in the vicinity of a closure, and for producing a control signal operative to change the position of the closure in response to the detection and identity of the mammal.

25. The system of claim 24, wherein the detector detects the presence of a mammal in the exterior of the structure, and wherein the control signal is operative to change the position of the closure toward a closed position in response to the detection of the mammal's presence and not recognizing the mammal to be an authorized mammal.

26. The system of claim 24, further including a closure path detector to detect the presence of a person object in the path of the closure, and for inhibiting movement of the closure to a completely closed position in response to detection of the person or object.

27. A ventilation control system for use in a building structure, comprising:
a detector for detecting the presence of an allergenic condition in the structure, and for producing a control signal operative to change the ventilation system in response to the detection of the allergenic condition.

28. The system of claim 27, wherein the allergenic condition is at least one of pollen, weed, mold and spores.

29. A control system for use in a building structure, comprising:
a detector for detecting the presence of an object exterior to the structure including determining whether the object is an authorized object, and for producing a control signal operative to change the position of a closure in the structure in response to the detection of said object and whether it is authorized.

30. The system of claim 29, wherein the object is a person.

31. The system of claim 29, wherein the object is a vehicle.

32. A control system for use in a building structure, comprising:
a detector for detecting the presence of an object exterior to the structure, determining whether the object is an authorized object, and for producing a communication signal to notify the condition to a remote location and for changing the position of a closure in response to the presence of the object not being authorized.

33. The system of claim 32, wherein the object is a person.

34. The system of claim 33, wherein the object is a vehicle.

35. A closure control system for use in a building structure, comprising:
a detector for detecting the presence of an object exterior to the structure, determining whether the object is an authorized object, and for producing a control signal operative to change the position of a closure in the structure in response to the detection of said object and whether it is authorized; and
a controller for storing information regarding the position of a closure based on a time schedule, and for producing a control signal operative to change the position of the closure in response to the time schedule information.

36. A closure control system for use in a building structure, comprising:
a remote, off-premises controller for producing a control signal indicating the desired position of a closure in a structure, which control signal is communicated from the remote, off-premises controller over a cellular telephone network; and an on-premises controller, for receiving the control signal from the remote, off-premises controller over the cellular telephone network, and for producing a closure position control signal operative to change the position of the closure in response to the control signal from the off-premises controller, or in response to detection of an object in the vicinity of the closure which is not an authorized object.

37. A closure control system for use in a building structure, comprising:
a on-premises detector and controller for detecting the status of and controlling the closure position of a closure on the premises of a building structure and for closing the closure in response to the detection of an object in the vicinity of the closure which is not an authorized object;
a remote, off-premises controller for communicating with an on-premises detector and controller over a cellular telephone network, and for determining the status of the closure position from the remote location.

38. The system of claim 37, wherein the remote off-premises controller generates a control signal operative to change the closure position from a remote location over the cellular telephone network.

39. (canceled)

40. (canceled)

41. (canceled)
